(19) United States
(12) Patent Application Publication
(10) Pub. No.: US 2010/0014670 A1
(43) Pub. Date: Jan. 21, 2010

(54) One-Way Hash Extension for Encrypted Communication

(75) Inventors: Larry C. Li, Austin, TX (US); Christopher Darilek, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/402,638

(22) Filed: Mar. 12, 2009

Related U.S. Application Data
(60) Provisional application No. 61/081,917, filed on Jul. 18, 2008.

(51) Int. Cl. H04K 1/00; H04L 9/28

(52) U.S. Cl. 380/255; 380/28

(57) ABSTRACT

Various apparatuses, methods and systems for encrypted communication are disclosed herein. For example, some embodiments provide an apparatus for encrypted communication, including a transmitter and a receiver. The transmitter includes a first one-way hash calculator and an encryptor. The encryptor has a code input connected to a hash value output of the first one-way hash calculator. The receiver includes a second one-way hash calculator. The first and second one-way hash calculators are configured with the same key. The decryptor has a code input connected to the hash value output of the second one-way hash calculator. The decryptor data input is connected to the encryptor output.

### CROSS REFERENCE TO RELATED APPLICATION

The present application claims priority to U.S. Provisional Patent Application No. 61/081,917 entitled “XSHA-1: SHA-1 EXTENSION FOR ENCRYPTED COMMUNICATION”, and filed on Jul. 18, 2008. The aforementioned application is assigned to an entity common hereto, and the entirety of the aforementioned application is incorporated herein by reference for all purposes.

### BACKGROUND

A one-way hash is a cryptographic function or device that is used between a pair of electronic systems for authentication, message integrity checks, digital signatures, etc. The electronic systems use the one-way hash to ensure that they are authorized to communicate with each other before continuing with other interactions. Generally, a hash is a function that calculates a fixed size value from a block of data, where the fixed size value is determined by the contents of the block of data and is as nearly as possible unique. A one-way hash is one in which the block of data cannot be reconstructed from the fixed size value.

One well known and commonly used one-way hash is the SHA-1 (secure hash algorithm) function. The SHA-1 function is used in a wide range of applications, such as the secure sockets layer (SSL) widely used on the Internet, secure shell (SSH), pretty good privacy (PGP), and other cryptographic systems, as well as in standalone applications requiring authentication between a pair of electronic systems. The SHA-1 function is a shared key or symmetric key function, in which the electronic systems use the same key for encryption and decryption. An example of an SHA-1 keyed-hash message authentication code (HMAC) function is illustrated in FIG. 1. A transmitter 10 and a receiver 12 are both provided with a secret key (K) 14. The transmitter 10 may authenticate the receiver 12 by transmitting a challenge (C) 16 to the receiver 12. The transmitter 10 and receiver 12 each process the challenge 16 in a SHA-1 function 20. Because the transmitter 10 and receiver 12 both have the same SHA-1 function 20, the same secret key 14 and the same challenge 16, the unique response (R) 22 generated by the SHA-1 function 20 in the transmitter 10 will be the same as the unique response (R′) 24 generated by the SHA-1 function 20 in the receiver 12. The receiver 12 responds to the challenge 16 from the transmitter 10 by returning the unique response 24. The transmitter 10 then compares the unique response 22 generated in the transmitter 10 with the unique response 24 returned by the receiver 12, and if they match, the receiver 12 is authenticated to the transmitter 10.

Generally, it is mathematically very difficult to recover the challenge 16 using the unique response 22 and the secret key 14. SHA-1 and other one-way hash functions are therefore unsuitable for secure communication in which the data is encrypted.

### SUMMARY

Various apparatuses, methods and systems for encrypted communication are disclosed herein. For example, some embodiments provide an apparatus for encrypted communication, including a transmitter and a receiver. The transmitter includes a first one-way hash calculator and an encryptor. The encryptor has a code input connected to a hash value output of the first one-way hash calculator. The receiver includes a second one-way hash calculator. The first and second one-way hash calculators are configured with the same key. The decryptor has a code input connected to the hash value output of the second one-way hash calculator. The decryptor data input is connected to the encryptor output.

In an embodiment of the apparatus, the encryptor and the decryptor apply a same operation to the data inputs with the codes.

In an embodiment of the apparatus, the encryptor and the decryptor apply an XOR operation to the data inputs with the codes.

In an embodiment of the apparatus, the first one-way hash calculator and the second one-way hash calculator each comprise a SHA-1 device.

In an embodiment of the apparatus, the transmitter is adapted to transmit an initial challenge to an input of the second one-way hash calculator in the receiver before transmitting encrypted messages from the encryptor output to the decryptor data input.

In an embodiment of the apparatus, the transmitter and receiver are each configured with a same initial challenge to process in the first and second one-way hash calculators.

In an embodiment of the apparatus, the transmitter is adapted to process unencrypted messages in the first one-way hash calculator to generate codes for the encryptor and the receiver is adapted to process unencrypted messages from an output of the decryptor in the second one-way hash calculator to generate codes for the decryptor.

In an embodiment of the apparatus, the transmitter is adapted to process encrypted messages in the first one-way hash calculator to generate codes for the encryptor and the receiver is adapted to process encrypted messages from the encryptor output in the second one-way hash calculator to generate codes for the decryptor.

In an embodiment of the apparatus, the transmitter and the receiver comprise integrated circuits.

Other embodiments provide methods of communicating securely. For example some embodiment provide a method including calculating a hash value using a first one-way hash calculator in a transmitter, encrypting a data message in an encryptor in the transmitter using the hash value to generate an encrypted message, transmitting the encrypted data message to a receiver, calculating the hash value using a second one-way hash calculator in the receiver, and decrypting the encrypted data message in a decryptor in the receiver using the hash value to recover the data message.

An embodiment of the method also includes calculating the hash value using the first one-way hash calculator based on the data message and calculating the hash value using the second one-way hash calculator based on the recovered data message.

An embodiment of the method also includes calculating the hash value using the first one-way hash calculator based on the encrypted data message and calculating the hash value using the second one-way hash calculator based on the encrypted data message.

An embodiment of the method also includes first calculating an initial hash value in the using the first one-way hash calculator in the transmitter and the second one-way hash calculator in the receiver before encrypting and decrypting the data message.

In an embodiment of the method, the hash values are calculated with a same key in the first one-way hash calculator and the second one-way hash calculator.

In an embodiment of the method, the encryptor and the decryptor comprise XOR operators.

In an embodiment of the method, the first and second one-way hash calculators comprise SHA-1 devices.

An embodiment of the method also includes periodically calculating a new hash value based on a new data message in the first and second one-way hash calculators.

This summary provides only a general outline of some particular embodiments. Many other objects, features, advantages and other embodiments will become more fully apparent from the following detailed description, the appended claims and the accompanying drawings.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a prior art SHA-1 HMAC function used for authentication.

FIG. 2 depicts a block diagram of a host device and a peripheral device arranged to exchange encrypted communication in accordance with some embodiments.

FIGS. 3a and 3b depict a transmitter and a receiver with a one-way hash extension in accordance with some embodiments.

FIGS. 4a and 4b depict a transmitter and a receiver with a one-way hash extension in accordance with some embodiments.

FIG. 5 depicts a flow chart of a method for securely communicating in accordance with some embodiments.

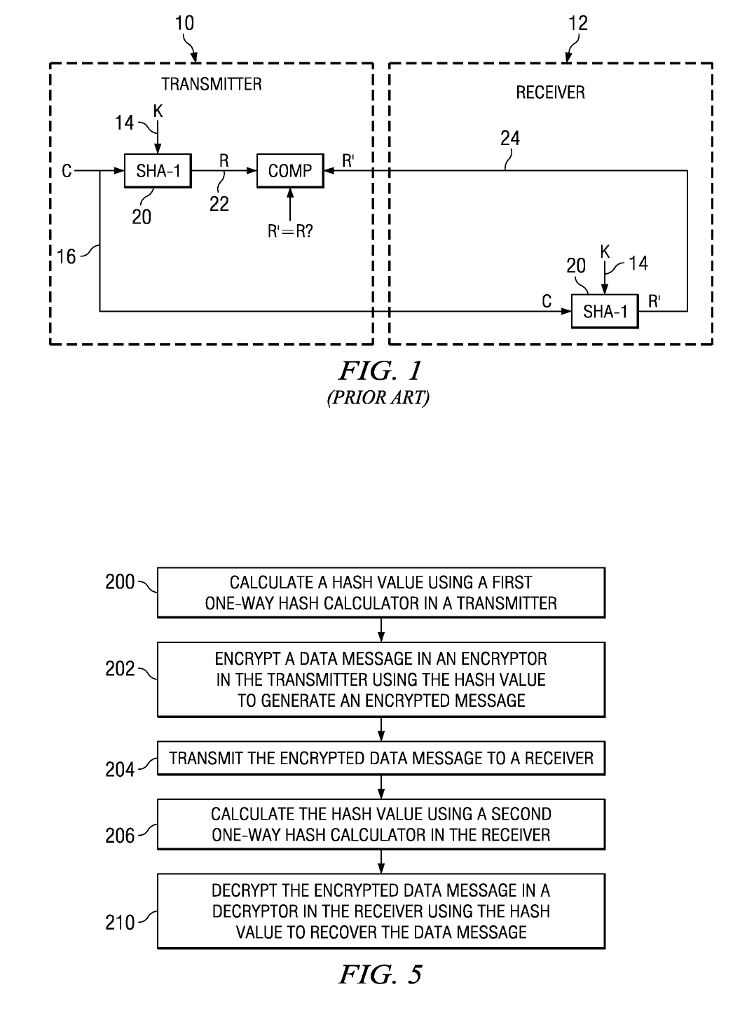

### DESCRIPTION

The drawings and description, in general, disclose various embodiments of a one-way hash extension for encrypted communication between electronic systems. The encryption extension leverages a one-way hash function such as SHA-1 to provide a two-way encryption function for secure communication, using a one-way function that is unsuitable for secure communication to create a two-way encryption that is suitable for secure communication. Devices already including a one-way hash function may be adapted for encrypted communication without requiring a full new encrypted communication function. The encryption extension disclosed herein is not limited to the SHA-1 function but may use any suitable one-way hash function. The one-way hash function is used to generate a response or hash value based on the secret key and the challenge or data message, and the encryptor is used to encrypt the data message using a function such as an XOR operator. Because the transmitter and receiver both have the same key and the same challenge, they will both generate the same hash value and will be able to encrypt and decrypt the message using the XOR or other encryption function. Note that the term “challenge” is used generically herein for the data processed by a one-way hash function, and the term “response” is used generically for the hash value generated by the one-way hash function from the challenge and the key. The encryptor is not limited to the XOR function used in various embodiments disclosed herein, although the XOR function is a simple and computationally efficient operator. The hash value used to encrypt data messages may be changed periodically by replacing the challenge to the one-way hash functions with portions of the data message, either encrypted or unencrypted.

The term “one-way hash” is used herein to refer to a function or device that applies a secret key to a block of data to generate a hash value for which the inverse transform is mathematically difficult to achieve. The one-way hash function is “one-way” only in that the data is processed by the one-way hash function to form the hash value, but it is mathematically very difficult and thus impractical to process the hash value and recover the data. In the case of the SHA-1 HMAC function, the response or hash value generated inside a receiver is simply returned to a transmitter and compared with the hash value generated in the transmitter, and the two hash values are compared in the transmitter to authenticate the receiver. The response from the receiver is merely compared in the transmitter, and the original challenge or data is not recovered. Thus, one-way hash functions are not suitable for sending encrypted data, because the encrypted messages cannot easily be decrypted even knowing the secret key.

For two-way secure communication, a message is encrypted, then decrypted to recover the original message. For example, one electronic device encrypts the message and transmits it to another electronic device, where it is decrypted to recover the original message. The term “two-way” does not necessarily mean that encrypted data is sent both ways or bidirectionally between a pair of electronic devices and decrypted at both ends, although the electronic devices may certainly each be equipped with a transmitter and receiver having the one-way hash extension disclosed herein to facilitate bidirectional encrypted communication. The inclusion of a full two-way encryption system is generally much more complex than a one-way authentication system. However, in systems already requiring a one-way authentication system, the one-way hash extension disclosed herein adds a thin, computationally efficient layer enabling secure encrypted communication based on the existing one-way hash function.

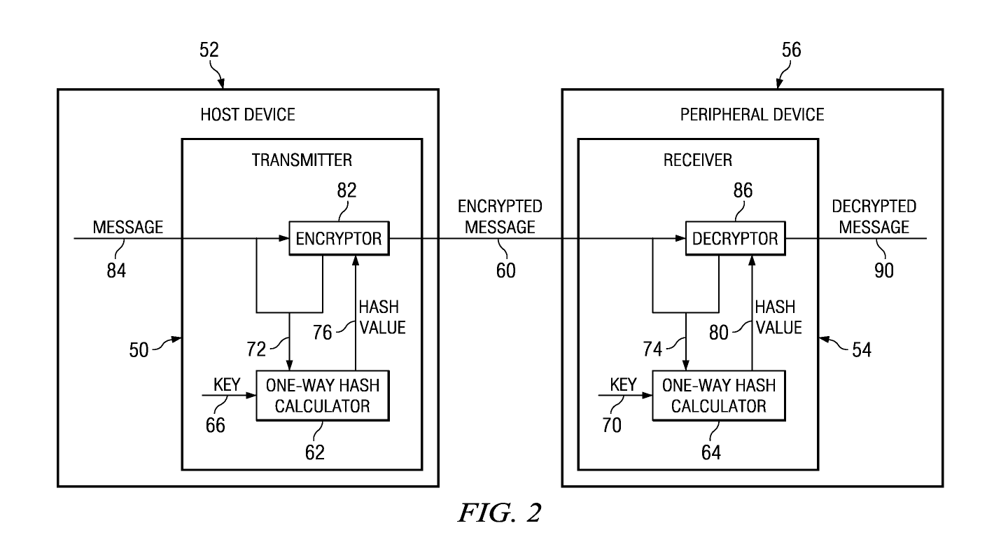

Turning now to FIG. 2, the encryption extension may be used to provide encrypted communication between a transmitter 50 in a host device 52 and a receiver 54 in a peripheral device 56. The host device 52 and peripheral device 56 may be any electronic devices needing to pass data securely in an encrypted message 60. In other words, the one-way hash extension disclosed herein may be used in any electronic devices. The one-way hash extension is also not limited to the example configurations shown in the drawings. For example, the host device 52 may be a notebook computer with the peripheral device 56 being a subsystem of the notebook computer.

The transmitter 50 and receiver 54 are each equipped with a one-way hash calculator 62 and 64, respectively, such as SHA-1 devices. Each of the one-way hash calculators 62 and 64 are configured or provided with the same shared secret key 66 and 70. Given the same data at the inputs 72 and 74 and the same keys 66 and 70, the one-way hash calculators 62 and 64 in the transmitter 50 and receiver 54 will both produce the same hash values 76 and 80. The hash value 76 in the transmitter 50 is used by an encryptor 82 to encrypt a data message 84, thereby producing an encrypted message 60. The hash value 80 in the receiver 54 is used by a decryptor 86 to decrypt the encrypted message 60, thereby producing a decrypted message 90 and recovering the original message 84.

The data used as a challenge at the inputs 72 and 74 of the one-way hash calculators 62 and 64 may be changed periodically to change the hash values 76 and 80 used to encrypt and decrypt the encrypted message 60 in the encryptor 82 and decryptor 86. This allows the encryptor 82 and decryptor 86 to use a simple and computationally efficient algorithm, because the hash values 76 and 80 or codes used for the encryption and decryption will be changing over time. Thus, even if one portion of an encrypted message 60 is captured and decoded, subsequent portions will be encrypted differently. As will be described in more detail below, the hash values 76 and 80 calculated by the one-way hash calculators 62 and 64 may be based on initial challenges, unencrypted data messages and/or encrypted messages.

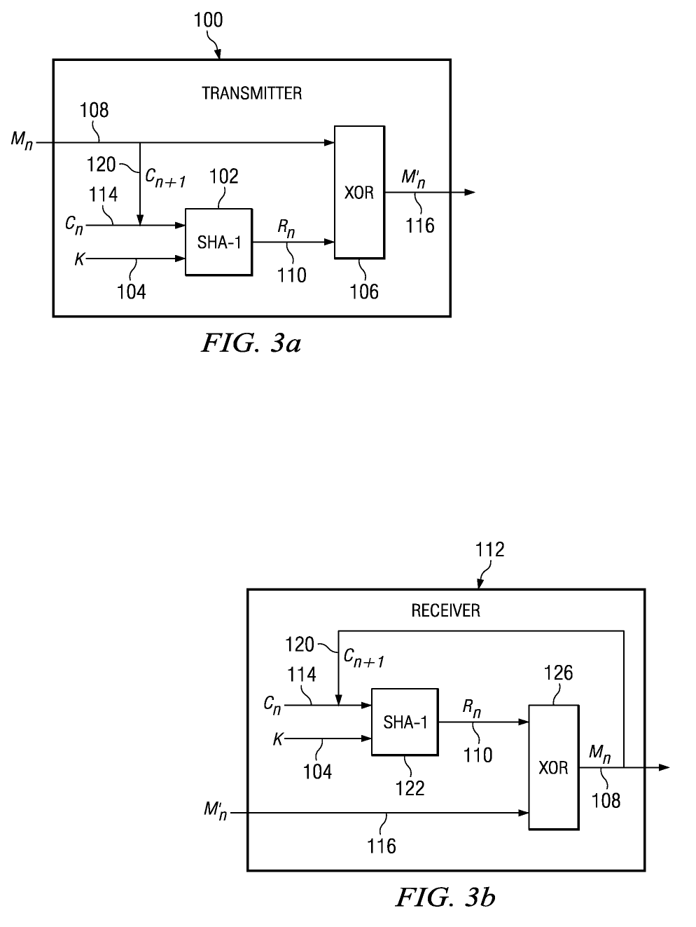

Turning now to FIG. 3a, an embodiment of a transmitter 100 with a one-way hash extension will be described. A SHA-1 calculator 102 is provided and configured with a key 104. An XOR device 106 is connected to the output of the SHA-1 calculator 102 to encrypt a data message 108 using the hash value or response 110 from the SHA-1 calculator 102. Again, the transmitter 100 is not limited to use with a SHA-1 calculator and XOR device but may include any type of one-way hash function and encryptor. The transmitter 100 may be used with a receiver 112 as illustrated in FIG. 3b.

The operation of the transmitter 100 is summarized as follows:

1. Initial condition, n=0, C₀=initial challenge

2. Cₙ is sent to the receiver

3. Cₙ along with secret key K is applied to SHA-1 calculator to create Rₙ

4. Rₙ and original message M, are XOR'ed to create encrypted message M′ₙ

5. M′ₙ is sent to the receiver

6. Mₙ is then used as the next challenge (i.e., Cₙ₊₁=Mₙ)

7. n=n+1

8. Go to step 3 and repeat until all messages are sent

In the first and second steps, an initial challenge C₀ is provided in the transmitter 100 and is sent to a receiver. In one embodiment, the initial challenge C₀ is transmitted unencrypted to the receiver by the transmitter 100, just as it would be in traditional SHA-1 authentication as described above.

In another embodiment, the initial challenge C₀ may be provided to both the transmitter 100 and receiver 112 in another manner, such as by hard-coding or hard-wiring the initial challenge C₀ in the transmitter 100 and receiver 112.

In the third step, the challenge Cₙ 114 is processed in the SHA-1 calculator 102 using the key 104 to generate a response Rₙ 110. As described above, this is a one-way function, and the challenge Cₙ 114 is mathematically difficult to retrieve from the response Rₙ 110, even with the key 104. The response Rₙ 110 is therefore used only as a code to encrypt and decrypt a message, given that the same response Rₙ 110 can be generated in the transmitter 100 and receiver 112 using the SHA-1 function. In the fourth step, the response Rₙ 110 and a message Mₙ 108 are combined in an XOR device to create an encrypted message M′ₙ 116. In other embodiments, the response Rₙ 110 is used in any suitable way as a code or seed value to encrypt the message Mₙ 108. The encrypted message M′ₙ 116 is transmitted to the receiver 112 in any suitable manner in the fifth step, whether wired, wirelessly, or using any other communication method between the transmitter 100 and receiver 112.

In the sixth step, the decrypted message Mₙ 108 is used as the next challenge Cₙ₊₁ 120 to the SHA-1 calculator 102 in the transmitter 100. The response Rₙ 110 used to encode the message Mₙ 108 thus changes periodically, so that even if the encrypted message M′ₙ 116 is intercepted, the encryption on each message M′ₙ encrypted using a different response Rₙ 110 would have be broken separately. The period at which the response Rₙ is changed may be adapted as desired, from changing with each message Mₙ 108 or less frequently. For example, if a data block is divided into a group of messages or packets with a checksum on the group that is transmitted after the other packets in the group, the challenge Cₙ may be based on the checksums to reduce the processing load in the transmitter 100 and receiver 112.

In steps 7 and 8, the transmitter 100 moves on to the next message Mₙ 108 and repeats the process from step 3 until all the messages Mₙ 108 have been sent.

Turning now to FIG. 3b, the receiver 112 performs the inverse operation to decrypt the encrypted messages M′ₙ 116 and recover the unencrypted messages Mₙ 108. A SHA-1 calculator 122 is provided and configured with the same key 104 as in the transmitter 100. An XOR device 126 is connected to the output of the SHA-1 calculator 122 to decrypt encrypted messages M′ₙ 116 using the hash value or response 110 from the SHA-1 calculator 122.

The operation of the receiver 112 is summarized as follows:

1. Initial condition, n=0, C₀=first packet from the transmitter 100

2. Cₙ along with secret key K is applied to SHA-1 calculator to create Rₙ

3. Receive encrypted message M′ₙ

4. Rₙ and M′ₙ applied to XOR to recover the original message Mₙ

5. Mₙ is used as the next challenge (i.e., Cₙ₊₁=Mₙ)

6. n=n+1

7. Go to step 3 and repeat until all messages are received

In the first and second steps, the initial challenge C₀ 114 is either received from the transmitter 100 or otherwise provided in the receiver 112 as discussed above. The initial challenge C₀ 114 is processed in the SHA-1 calculator 122 using the key 104 to generate a response Rₙ 110. In the third and fourth steps, the encrypted message M′ₙ 116 is received and applied to the XOR device 126 with the response Rₙ 110 to recover the original message Mₙ 108.

In the fifth step, the recovered message Mₙ 108 is used as the next challenge Cₙ₊₁ 120 to the SHA-1 calculator 122 in the receiver 112. The response Rₙ 110 used to decode the encoded message M′ₙ 116 thus changes periodically to match that in the transmitter 100. In steps 6 and 7, the receiver 112 moves on to the next encrypted message M′ₙ 116 and repeats the process from step 3 until all the encrypted messages M′ₙ 116 have been received and decrypted.

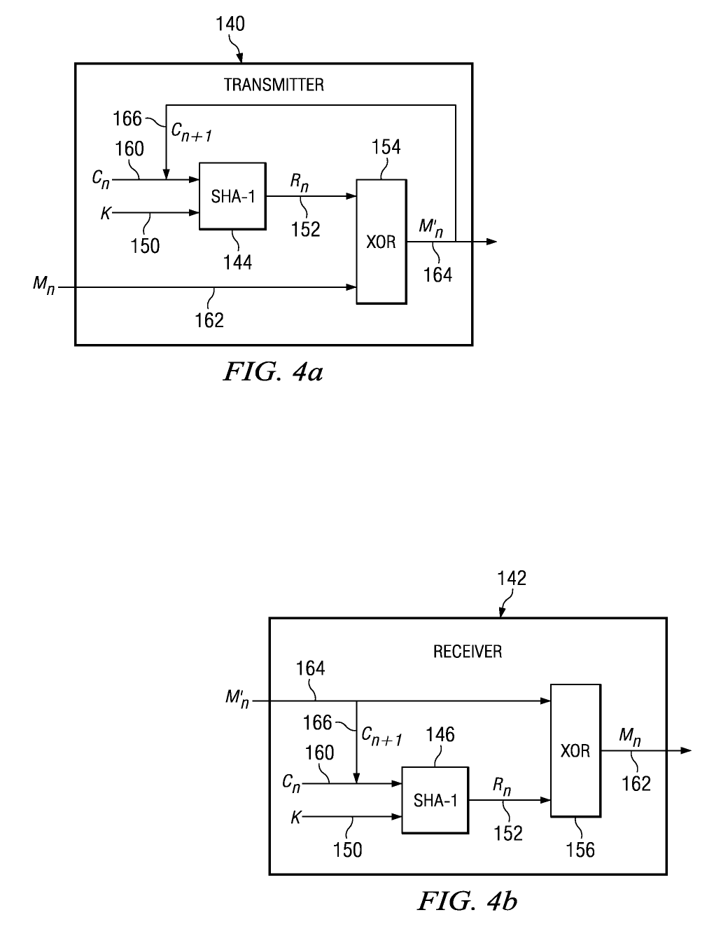

Turning now to FIGS. 4a and 4b, another embodiment of a transmitter 140 and receiver 142 having a one-way hash extension will be described. In this embodiment, encrypted messages are used as challenges to SHA-1 calculators 144 and 146 rather than unencrypted messages 108 as in FIGS. 3a and 3b. The SHA-1 calculators 144 and 146 are configured with a secret key 150, and the response 152 from the SHA-1 calculators 144 and 146 is used in XOR devices 154 and 156 to encrypt and decrypt messages.

The operation of the transmitter 140 is summarized as follows:

1. Initial condition, n=0, C₀=initial challenge

2. Cₙ is sent to the receiver

3. Cₙ along with secret key K is applied to SHA-1 calculator to create Rₙ

4. Rₙ and original message Mₙ are XOR'ed to create encrypted message M′ₙ

5. M′ₙ is sent to the receiver

6. M′ₙ is then used as the next challenge (i.e., Cₙ₊₁=M′ₙ)

7. n=n+1

8. Go to step 3 and repeat until all messages are sent

In the first and second steps, an initial challenge C₀ is provided in the transmitter 140 and is sent to the receiver 142 or is otherwise provided to the receiver 142. In the third step, the challenge Cₙ 160 is processed in the SHA-1 calculator 144 using the key 150 to generate a response Rₙ 152. In the fourth step, the response Rₙ 152 and a message Mₙ 162 are combined in the XOR device 154 to create an encrypted message M′ₙ 164. The encrypted message M′ₙ 164 is transmitted to the receiver 142 in the fifth step, and is used in the sixth step as the next challenge Cₙ₊₁ 166 to the SHA-1 calculator 144 in the transmitter 140. In the seventh and eighth steps, the transmitter 140 moves on to the next message Mₙ 162 and repeats the process from step 3 until all the messages Mₙ 162 have been sent.

The receiver 142 performs the inverse operation to decrypt the encrypted messages M′ₙ 164. The operation of the receiver 142 is summarized as follows:

1. Initial condition, n=0, C₀=first packet from the transmitter

2. Cₙ along with secret key K is applied to SHA-1 calculator to create Rₙ

3. Receive encrypted message M′ₙ

4. Rₙ and M′ₙ applied to XOR to recover the original message Mₙ

5. M′ₙ is used as the next challenge (i.e., Cₙ₊₁=M′ₙ)

6. n=n+1

7. Go to step 3 and repeat until all messages are received

In the first and second steps, the initial challenge C₀ 160 is either received from the transmitter 140 or otherwise provided in the receiver 142 as discussed above. The initial challenge C₀ 160 is processed in the SHA-1 calculator 146 using the key 150 to generate the response Rₙ 152. In the third and fourth steps, the encrypted message M′ₙ 164 is received and applied to the XOR device 156 with the response Rₙ 152 to recover the original message Mₙ 162. In the fifth step, the encrypted message M′ₙ 164 is used as the next challenge Cₙ₊₁ 166 to the SHA-1 calculator 146 in the receiver 142. In the sixth and seventh steps, the receiver 142 moves on to the next encrypted message M′ₙ 164 and repeats the process from the third step until all the encrypted messages M′ₙ 162 have been received and decrypted. It may be noted that the embodiments of FIGS. 3a and 3b and of FIGS. 4a and 4b have a similar and symmetrical implementation, where the embodiment of FIGS. 3a and 3b use unencrypted messages as challenges and the embodiment of FIGS. 4a and 4b use unencrypted messages as challenges. The transmitter 100 of FIG. 3a is configured similarly to the receiver 142 of FIG. 4b, and the transmitter 140 of FIG. 4a is configured similarly to the receiver 112 of FIG. 3b.

The one-way authentication extension disclosed herein is tolerant of some challenge-response pairs being compromised by intercepting an encrypted message during transmission and decoding it in some unauthorized manner. Because the challenges are periodically changed based on the message content, whether using encrypted or unencrypted messages, the unauthorized interception and decryption of one message will not substantially aid in decryption of other intercepted messages.

The one-way hash extension disclosed herein also provides a configurable balance between speed and security. Because the one-way hash function may be more computationally intensive than the XOR operation, speed may be improved by reducing the frequency of generating new responses or hash values. Alternatively, security may be emphasized by changing the hash values more frequently.

The one-way hash calculators and encryptor/decryptors may be embodied in a number of manners, such as in electronic hardware such as an application specific integrated circuit (ASIC) or a programmable gate array, or using firmware or software that operates in conjunction with transmitter and receiver hardware, etc. Many implementations of a SHA-1 calculator are available and are publically known and will therefore not be described in detail. The transmitter and receiver using the one-way hash extension disclosed herein may include any suitable control system or state machine to periodically replace the challenge with a previous encrypted or unencrypted message to change the hash value used to encrypt a new message.

A method of communicating securely using the one-way hash extension disclosed herein is summarized in the flow chart of FIG. 5. Various embodiments of the method may include calculating a hash value using a first one-way hash calculator in a transmitter (block 200), encrypting a data message in an encryptor in the transmitter using the hash value to generate an encrypted message (block 202), transmitting the encrypted data message to a receiver (block 204), calculating the hash value using a second one-way hash calculator in the receiver (block 206), and decrypting the encrypted data message in a decryptor in the receiver using the hash value to recover the data message (block 210).

While illustrative embodiments have been described in detail herein, it is to be understood that the concepts disclosed herein may be otherwise variously embodied and employed.

What is claimed is:

1. An apparatus for encrypted communication, the apparatus comprising:
a transmitter comprising:
a first one-way hash calculator, wherein the first one-way hash calculator is configured with a key; and
an encryptor having a data input and a code input and an output, wherein the encryptor code input is connected to a hash value output of the first one-way hash calculator; and
a receiver comprising:
a second one-way hash calculator, wherein the second one-way hash calculator is configured with the key; and
a decryptor having a data input and a code input, wherein the decryptor code input is connected to a hash value output of the second one-way hash calculator and the decryptor data input is connected to the encryptor output.

2. The apparatus of claim 1, wherein the encryptor and the decryptor apply a same operation to the data inputs with codes at the code inputs.

3. The apparatus of claim 2, wherein the encryptor and the decryptor apply an XOR operation to the data inputs with the codes.

4. The apparatus of claim 1, wherein the first one-way hash calculator and the second one-way hash calculator each comprise a SHA-1 device.

5. The apparatus of claim 1, wherein the transmitter is adapted to transmit an initial challenge to an input of the second one-way hash calculator in the receiver before transmitting encrypted messages from the encryptor output to the decryptor data input.

6. The apparatus of claim 1, wherein the transmitter and receiver are each configured with a same initial challenge to process in the first and second one-way hash calculators.

7. The apparatus of claim 1, wherein the transmitter is adapted to process unencrypted messages in the first one-way hash calculator to generate codes for the encryptor.

8. The apparatus of claim 7, wherein the receiver is adapted to process unencrypted messages from an output of the decryptor in the second one-way hash calculator to generate codes for the decryptor.

9. The apparatus of claim 1, wherein the transmitter is adapted to process encrypted messages in the first one-way hash calculator to generate codes for the encryptor.

10. The apparatus of claim 9, wherein the receiver is adapted to process encrypted messages from the encryptor output in the second one-way hash calculator to generate codes for the decryptor.

11. The apparatus of claim 1, wherein the transmitter comprises an integrated circuit and wherein the receiver comprises an integrated circuit.

12. A method of communicating securely, the method comprising:
calculating a hash value using a first one-way hash calculator in a transmitter;
encrypting a data message in an encryptor in the transmitter using the hash value to generate an encrypted message;
transmitting the encrypted data message to a receiver;
calculating the hash value using a second one-way hash calculator in the receiver; and
decrypting the encrypted data message in a decryptor in the receiver using the hash value to recover the data message.

13. The method of claim 12, further comprising calculating the hash value using the first one-way hash calculator based on the data message and calculating the hash value using the second one-way hash calculator based on the recovered data message.

14. The method of claim 12, further comprising calculating the hash value using the first one-way hash calculator based on the encrypted data message and calculating the hash value using the second one-way hash calculator based on the encrypted data message.

15. The method of claim 12, further comprising first calculating an initial hash value in the using the first one-way hash calculator in the transmitter and the second one-way hash calculator in the receiver before encrypting and decrypting the data message.

16. The method of claim 12, wherein the hash values are calculated with a same key in the first one-way hash calculator and the second one-way hash calculator.

17. The method of claim 12, wherein the encryptor and the decryptor comprise XOR operators.

18. The method of claim 12, wherein the first and second one-way hash calculators comprise SHA-1 devices.

19. The method of claim 12, further comprising periodically calculating a new hash value based on a new data message in the first and second one-way hash calculators.

20. An encrypted communication system comprising:
a transmitter in an integrated circuit, the transmitter comprising:
a first SHA-1 one-way hash calculator, wherein the first one-way hash calculator is configured with a key; and
a first XOR device having a data input, a code input and an output, wherein the first XOR device code input is connected to a hash value output of the first SHA-1 one-way hash calculator; and
a receiver in an integrated circuit, the receiver comprising:
a second SHA-1 one-way hash calculator, wherein the second SHA-1 one-way hash calculator is configured with the key; and
a second XOR device having a data input and a code input, wherein the second XOR device code input is connected to a hash value output of the second one-way hash calculator and the second XOR device data input is connected to the first XOR device output, wherein the transmitter and receiver are each configured with a same initial challenge to process in the first and second SHA-1 one-way hash calculators, and wherein the first and second SHA-1 one-way hash calculators are configured to process data messages with the key and wherein the first XOR device is processed to encrypt the data messages with hash values from the first SHA-1 one-way hash calculator and wherein the second XOR device is processed to decrypt the data messages with hash values from the second SHA-1 one-way hash calculator, and wherein the hash values are periodically changed using the first and second SHA-1 one-way hash calculators based on changing data messages.
